(19) United States
(12) Patent Application Publication
(10) Pub. No.: US 2018/0246268 A1
(43) Pub. Date: Aug. 30, 2018

(54) LIQUID CRYSTAL DISPLAY DEVICE AND THE PRISM SHEET THEREOF

(71) Applicants: HKC CORPORATION LIMITED, Shenzhen (CN); CHONGQING HKC OPTOELECTRONICS TECHNOLOGY CORPORATION LIMITED, Chongqing (CN)

(72) Inventor: Yu-Jen CHEN, Chongqing (CN)

(73) Assignees: HKC CORPORATION LIMITED, Shenzhen (CN); CHONGQING HKC OPTOELECTRONICS TECHNOLOGY CORPORATI ON LIMITED, Chongqing (CN)

(21) Appl. No.: 15/553,467

(22) PCT Filed: Apr. 13, 2017
(86) PCT No.: PCT/CN2017/080398

§ 371 Date: Aug. 24, 2017

(30) Foreign Application Priority Data
Dec. 27, 2016 (CN) 201611229397.7

(51) Int. Cl. F21V 8/00

(52) U.S. Cl. CPC G02B 6/0053

(57) ABSTRACT

The present application relates to a liquid crystal display device. The liquid crystal display device comprises: a backlight module; a liquid crystal display panel; and a prism sheet, provided between the backlight module and the liquid crystal display panel, wherein the prism sheet comprises: a brightness enhancement film; and a plurality of prisms, wherein the prisms distributed on the brightness enhancement film individually have at least one angle, and an angle of the prisms distributed in a peripheral area is smaller than an angle of the prisms distributed in an in-plane area.

### TECHNICAL FIELD

The present application relates to a method for designing a backlight module, and particularly relates to a liquid crystal display device and the prism sheet thereof.

### BACKGROUND ART

TFT-LCD is short for thin film transistor liquid crystal display. TFT-LCD is a backlight type liquid crystal display, and it comprises a liquid crystal display panel and a backlight module. The liquid crystal display panel comprises: a first substrate (CF, color filter substrate), a second substrate (TFT, thin film transistor substrate), and liquid crystal (LC) sandwiched between the color filter substrate and the thin film transistor substrate. LCD displays images by rearranging liquid crystal molecules in the liquid crystal layer when a voltage is applied to the electrodes on the array substrate and the color filter substrate. Because LCD itself cannot emit light, a backlight module is required. A backlight module may comprise a light source such as a light emitting diode or a fluorescent lamp, and a light guide plate, a prism sheet, a diffuser, a protection plate and so on. The prism sheet has a regular pattern with a triangular section and concentrates light to increase the brightness. Generally, a backlight module comprises one prism sheet or a plurality of prism sheets that are stacked on each other, and each of the prism sheets has a regular pattern at the upper part and an irregular pattern at the lower part.

TFT-LCD, in order to highlight the oneness sense of the displayed images, trends to employ the frameless design, but when the border frame is eliminated, the problem of the side light leaking of the edges must be overcome, or else the phenomenon of peripheral light leaking emerges. The presently employed solution is to apply a layer of side seal around the end face of the edges of the open cell of the frameless products, to absorb the light ray and block the outcoming of the light ray. However, such a mode requires extra materials and manufacturing processes, and is very inconvenient.

### SUMMARY OF THE INVENTION

In order to solve the above technical problems, the object of the present application is to provide a method for designing a backlight module, and particularly relates to a liquid crystal display device to solve the problem of the side light leaking of the edges of frameless liquid crystal displays, without applying a circle of side seal around the frameless liquid crystal displays to absorb the leaked light, which simplifies the manufacturing process.

The object of the present application and the solving of technical problem thereof are achieved by using the following technical solution: a liquid crystal display device, comprising: a backlight module; a liquid crystal display panel; and a prism sheet, provided between the backlight module and the liquid crystal display panel, and the prism sheet comprises: a brightness enhancement film; and a plurality of prisms, wherein the prisms distributed on the brightness enhancement film individually have at least one angle, and an angle of the prisms distributed in a peripheral area is smaller than an angle of the prisms distributed in an in-plane area.

The object of the present application and the solving of its technical problem can be further achieved by using the following technical means:

A set of prism sheets comprises one or more prism sheets, and further comprises the prism sheet.

In an embodiment of the present application, the angles of the prisms are all in a range of 30 degrees to 60 degrees.

In an embodiment of the present application, the angles of the prisms in the peripheral area of the brightness enhancement film are in a range of 30 degrees to 45 degrees, and the angles of the prisms in the in-plane area of the brightness enhancement film are in a range of 45 degrees and 60 degrees; the in-plane area is corresponding to a displaying region of the liquid crystal display panel, and cross-sections of structures of the prisms in the in-plane area are of an isosceles triangle shape; and the peripheral area is corresponding to a non-displaying region of the liquid crystal display panel, and cross-sections of structures of the prisms in the peripheral area are of a right triangle shape, wherein acute angles of the right triangles in the peripheral area are facing the in-plane area.

In an embodiment of the present application, the prisms are a plurality of triangular edged strips arranged successively, and are provided at the light-exiting face of the prism sheet.

In an embodiment of the present application, the prism sheet has a compound angle of various prism angles.

In an embodiment of the present application, the plurality of prism sheets have no gap therebetween.

In an embodiment of the present application, the plurality of prism sheets are arranged on a flat plate, and the plurality of prism sheets have constant gaps therebetween.

In an embodiment of the present application, a material of the prisms is a thermoplastic resin or a synthetic material containing a thermoplastic resin, and the thermoplastic resin is a transparent material in the range of visible light.

### Advantageous Effects

The present application can solve the problem of the side light leaking of the edges of frameless liquid crystal displays, without applying a circle of side seal around the frameless liquid crystal displays to absorb the leaked light, which simplifies the manufacturing process. Additionally, the present application, by using the compound-angle prism sheet, forms total reflection at the periphery, which reduces the light that is refracted out of the glass end face, and thus prevents the light leaking of the edges of frameless products.

### BRIEF DESCRIPTION OF THE DRAWINGS

FIG. 1 is the schematic diagram of the structure of the backlight module of an exemplary traditional liquid crystal display.

FIG. 1a is the schematic diagram of the design of the outer frame of an exemplary display panel.

FIG. 1b is the schematic diagram of the frameless design of a display panel of an embodiment of the present application.

FIG. 2a is the schematic diagram of the exemplary design having frame.

FIG. 2b is the schematic diagram of the frameless side seal design of an embodiment of the present application.

FIG. 3a is the perspective view of the prism sheet of an embodiment of the present application.

FIG. 3b is the schematic diagram of the frameless liquid crystal display with a compound-angle prism sheet of an embodiment of the present application.

### DETAILED DESCRIPTION OF THE INVENTION

The descriptions of the following embodiments are intended to by referring to the attached drawings illustrate the special embodiments that can be implemented by the present application. The wordings regarding directions that are mentioned in the present application, such as “upper”, “lower”, “front”, “back”, “left”, “right”, “inner”, “outer”, and “side”, are merely by referring to the directions of the attached drawings. Therefore, the employed wordings regarding directions are intended to illustrate and understand the present application, and not to limit the present application.

The drawings and the description are considered as illustrative in natural, rather than restrictive. In the drawings, elements of the similar structures are indicated by the same reference numbers. Additionally, in order to facilitate the understanding and the describing, the sizes and the thicknesses of the components shown in the drawings are drawn randomly, but the present application is not limited thereto.

In the drawings, for the sake of clarity, the thicknesses of the layers, the films, the panels and the areas are exaggerated. In the drawings, in order to facilitate the understanding and the describing, the thicknesses of some layers and areas are exaggerated. It is understood that, when a component of, for example, the layers, the films, the areas or the substrate is described as “on” another component, the component may be directly on the another component, or there may be an intermediate component.

Additionally, in the description, unless explicitly described otherwise, the word “comprise” will be understood as meaning comprising the component, but not excluding any other component. Furthermore, in the description, “on” means being located above or below the target component, and does not mean that it must be located on the top in the gravity direction.

In order to further illustrate the technical means that are employed by the present application to achieve the predetermined invention object and the effects, the special embodiments, structures, characteristics and effects of the liquid crystal display device and its prism sheet that are provided according to the present application are in detailed described below by referring to the drawings and the preferred embodiments.

Liquid crystal displays (LCD) are devices where an electric field is applied to the liquid crystal between two sheets of glass substrate, to display digits or images. Liquid crystal consists of a substance of a state between liquid and solid. Because liquid crystal displays cannot emit light themselves, a backlight module is required to provide the light. The images are formed by controlling the light transmission of the liquid crystal display panels. The liquid crystal is uniformly provided in the liquid crystal display panels.

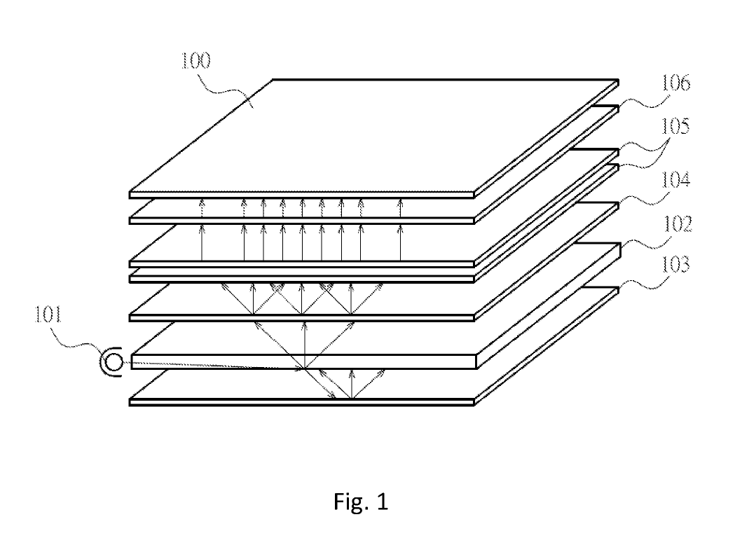

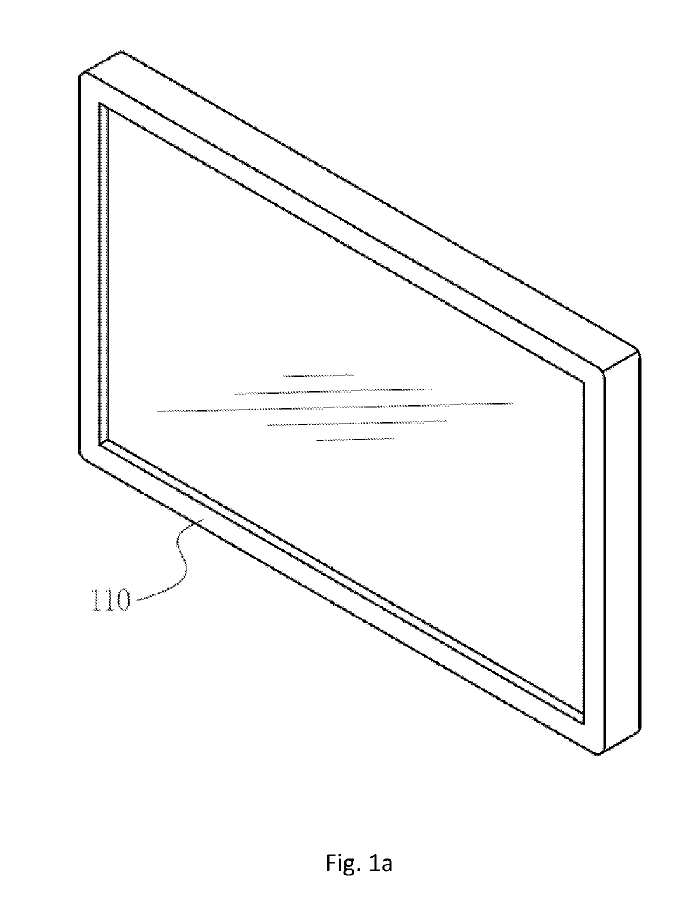

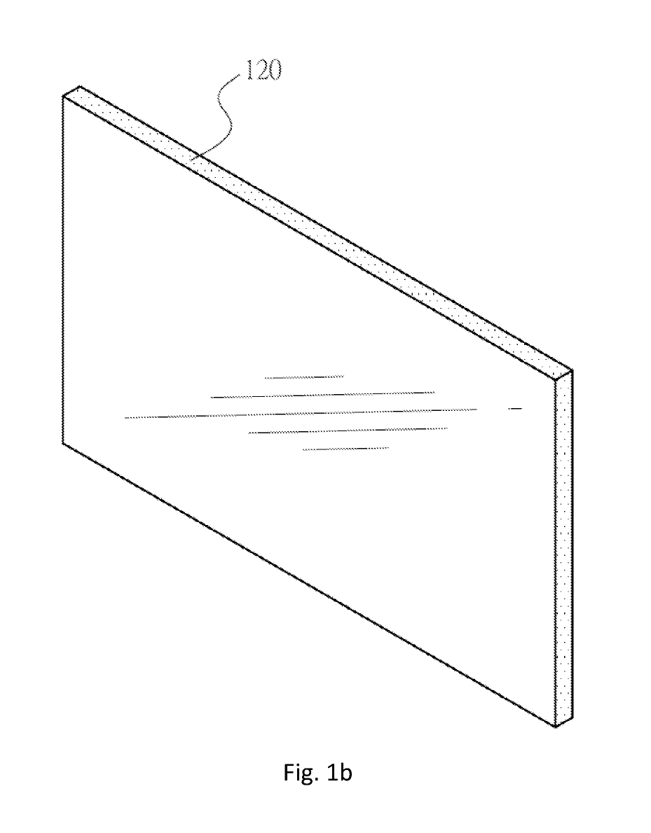

A typical backlight module of traditional liquid crystal displays (as shown in FIG. 1) comprises a light source 101, a light guide plate 102, a reflector plate 103, a diffuser 104, a prism sheet 105 and a protection plate 106. Firstly, the light source 101 is used to emit a light ray to the liquid crystal display, and at present various different light sources can be applied to liquid crystal displays. The light guide plate 102 is provided under the liquid crystal display panel 100, and is adjacent to the side of the light source 101. The light guide plate 102 is used to convert the spot-like light ray that is generated by the light source 101 into a plane-like light ray, and project the plane-like light ray to the liquid crystal display panel 100.

The reflector plate 103 is provided under the light guide plate 102. The reflector plate 103 is used to reflect the light ray emitted by the light source 101 to the liquid crystal display panel 100 in front of the reflector plate 103. The diffuser 104 is provided over the light guide plate 102, and is used to uniformize the light ray passing through the light guide plate 102. When the light ray is passing through the diffuser 104, the light ray is diffused to both the horizontal and vertical directions. At this point, the brightness of the light ray quickly decreases. In this regard, the prism sheet 105 is used to refract and concentrate the light ray, thereby increasing the brightness. Generally, two prism sheets 105 are arranged perpendicularly to one another.

The protection plate 106 is provided over the prism sheet 105. When two prism sheets 105 that are arranged perpendicularly to one another are employed, the protection plate 106 can prevent the scratching of the prism sheets 105, and prevent moire effect. The backlight modules of traditional liquid crystal displays comprise the above components, and the present application adds a new technical feature, a prism sheet 105.

Generally, when the prism sheet 105 is normally installed, a plurality of unit prisms are arranged on a transparent material film in a regular direction. The prism sheet 105 is used to refract the light ray having passed through the light guide plate 102 and diffused by the diffuser 104. Generally, if the width of the transmission and refraction of the light ray is relatively small, the light ray in the area of the transmission and refraction appears lighter. On the contrary, if the width of the transmission and refraction of the light ray is relatively large, the light ray in the area of the transmission and refraction appears darker.

In recent years, liquid crystal displays are developing from 17 inches or 19 inches to large size panels of larger than 40 inches. Therefore, how to maintain the density of the light ray emitted by the backlight module above a predetermined level, and how to uniformize the visible light ray, are important factors in designing the large size panels.

The liquid crystal display device of the present application may comprise a backlight module and a liquid crystal display panel. The liquid crystal display panel may comprise a thin film transistor substrate, a color filter substrate and a liquid crystal layer between the two substrates. Further, the brightness enhancement film (BEF) is applied in the liquid crystal displaying, to increase the front brightness of the display screen.

In an embodiment, the liquid crystal display panel of the present application may be a curve face display panel, and the liquid crystal display device of the present application may be a curve face display device.

FIG. 1a is the schematic diagram of the design of the outer frame of an exemplary display panel and FIG. 1b is the schematic diagram of the frameless design of a display panel of an embodiment of the present application. Referring to FIG. 1a and FIG. 1b, thin film transistor liquid crystal displays, in order to highlight the oneness sense of the displayed images, trend to employ the frameless design, but when the border frame 110 is eliminated, the problem of the side light leaking of the edges must be overcome, or else the phenomenon of peripheral light leaking emerges. The presently employed solution is to apply a layer of side seal 120 around the end face of the edges of the open cell of the frameless products, to absorb the light ray and block the outcoming of the light ray. However, such a mode requires extra materials and manufacturing processes, and is very inconvenient.

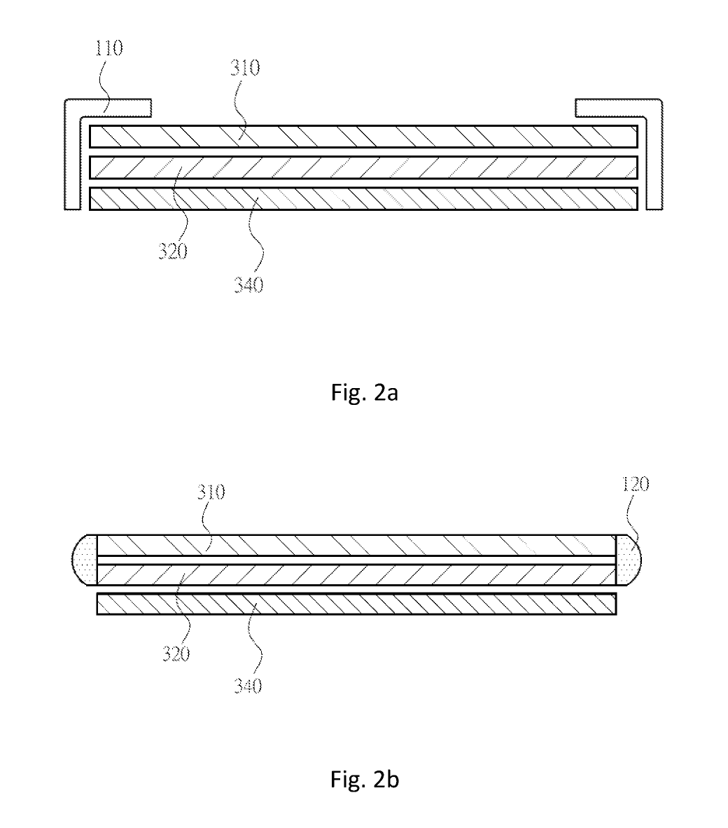

FIG. 2a is the schematic diagram of the exemplary design having frame and FIG. 2b is the schematic diagram of the frameless side seal design of an embodiment of the present application. Referring to FIG. 2a and FIG. 2b, in the frameless design, the problem of the light leaking of the side 110 should be solved, by applying a layer of side seal 120 around the end face of the edges of the open cell, to absorb the light ray and block the outcoming of the light ray. However, such a mode requires extra materials and manufacturing processes, and is very inconvenient.

The present application, by employing the characteristic of light concentrating of the prism sheet (BEF), concentrates the light beams, and, by employing the relation of the refractive indexes of glass and air, maintains the light rays at the total reflection condition, to prevent the light from leaking out. Because the refractive index of glass is larger than the refractive index of air, the angle of incidence of the glass side is larger than the angle of refraction of the air side. When the incident light is at a specific angle, the total reflection condition can be obtained, but because the angle of incidence is too small and has not reached the critical angle of total reflection, light leaking always occurs. Therefore, in the present application, by using the principle of the brightness enhancement film, the prism angles at the edges of the outer areas change enabling the light paths of the light sources at the periphery to be more perpendicular. Even if there is inclining, the angle of the inclining is very small, and a smaller angle facilitates reaching the total reflection criticality. The design characteristic is the compound prism angle, and that the prism angles at the periphery are smaller than the in-plane area.

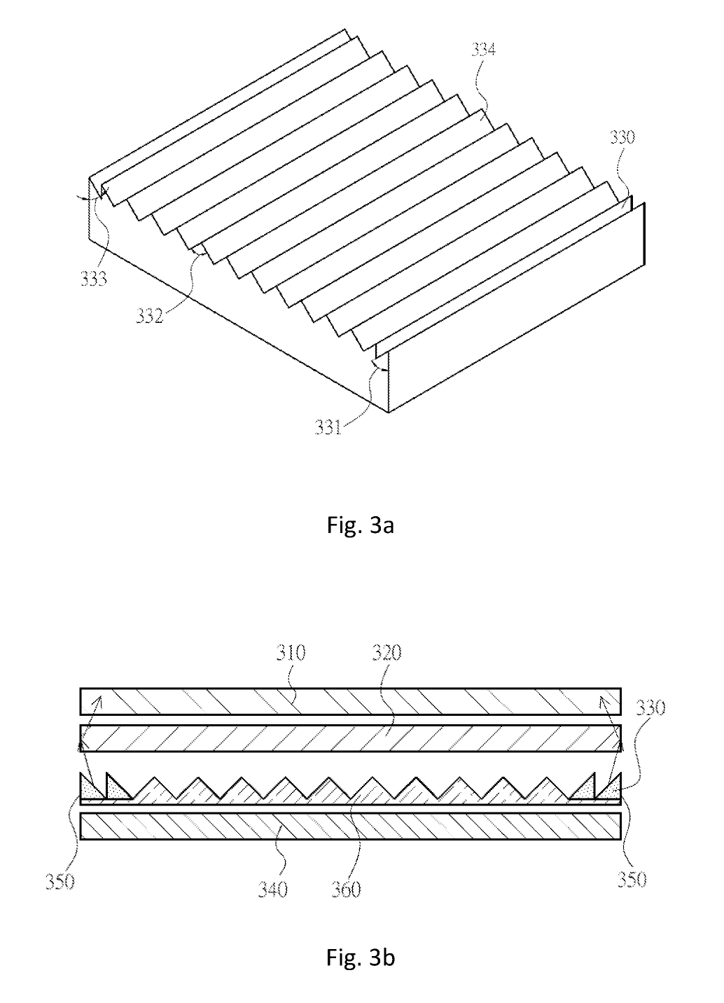

FIG. 3a is the perspective view of the prism sheet of an embodiment of the present application and FIG. 3b is the schematic diagram of the frameless liquid crystal display that has a compound-angle prism sheet of an embodiment of the present application. Referring to FIG. 3a and FIG. 3b, in an embodiment of the present application, a frameless liquid crystal display comprises: a liquid crystal display panel 320, a color filter 310 and a backlight module 340. The backlight module 340 has at least one brightness enhancement film 330, and a plurality of prisms distributed on the brightness enhancement film 330 individually have at least one angle 331, 332, 333. Additionally, an angle of the prisms 334 on the brightness enhancement film 330 in a peripheral area 350 is smaller than an angle of the prisms 334 in an in-plane area 360. The liquid crystal display panel may be a thin film transistor liquid crystal display panel or a curve face panel, and may also be another backlight-type liquid crystal display panel.

Referring to FIG. 3a and FIG. 3b, in an embodiment of the present application, a liquid crystal display device comprises: a backlight module 340; a liquid crystal display panel 320; and a prism sheet 334, provided between the backlight module 340 and the liquid crystal display panel 320, and the prism sheet 334 comprises: a brightness enhancement film 330; and a plurality of prisms 334, and the prisms 334 distributed on the brightness enhancement film 330 individually have at least one angle 331, 332, 333, and an angle of the prisms 334 on the brightness enhancement film 330 in a peripheral area 350 is smaller than an angle of the prisms 334 in an in-plane area 360.

Particularly, in some embodiments, the in-plane area 360 is corresponding to the displaying region of the liquid crystal display panel, and cross-sections of structures of the prisms in the in-plane area 360 are of an isosceles triangle shape; and the peripheral area 350 is corresponding to the non-displaying region of the liquid crystal display panel, and cross-sections of structures of the prisms in the peripheral area 350 are of a right triangle shape, wherein the acute angles of the right triangles in the peripheral area 350 are facing the in-plane area 360.

In an embodiment of the present application, the present invention, by employing the principle of light concentrating of the brightness enhancement film 330, configures different angle areas 331, 332, 333 of the prisms 334 around the brightness enhancement film 330, enabling it to effectively form a convergent light pattern, and facilitating forming the total reflection condition of the glass and air interface, so that light does not leaks out of the glass and thus light leaking does not occur. By employing such a design, the frameless liquid crystal display does not need to be applied a layer of side seal around the liquid crystal display panel to absorb the leaked light, simplifying the manufacturing process.

Referring to FIG. 3a and FIG. 3b, in an embodiment of the present application, the plurality of prism angles are all in a range of 30 degrees to 60 degrees.

Referring to FIG. 3a and FIG. 3b, in an embodiment of the present application, the prism angles 331, 333 in the peripheral area 350 of the brightness enhancement film 330 are in a range of 30 degrees to 45 degrees, and the prism angle 332 in the in-plane area 360 of the brightness enhancement film 330 is in a range of 45 degrees and 60 degrees.

Referring to FIG. 3a and FIG. 3b, in an embodiment of the present application, the prisms 334 are a plurality of triangular edged strips or edged strips of another shape arranged successively, and are provided at the light-exiting face of the prism sheet 334.

Referring to FIG. 3a and FIG. 3b, in an embodiment of the present application, the plurality of prism sheets 334 have no gap therebetween.

Referring to FIG. 3a and FIG. 3b, in an embodiment of the present application, the plurality of prism sheets 334 are arranged on a flat plate, and the plurality of prism sheets 334 have constant gaps therebetween.

Referring to FIG. 3a and FIG. 3b, in an embodiment of the present application, the prism sheet 334 has a compound angle of various prism angles, and forms total reflection at the periphery, reducing the light that is refracted out of the glass end face.

Referring to FIG. 3a and FIG. 3b, in an embodiment of the present application, an angle of the prisms 334 on the brightness enhancement film 330 in a peripheral area 350 is smaller than an angle of the prisms 334 in an in-plane area 360.

Referring to FIG. 3a, in an embodiment of the present application, a set of prism sheets comprises one or more prism sheets 334.

In an embodiment of the present application, the backlight module 340 further comprises a light guide plate, and a light source that is provided at a side surface or the back of the light guide plate. The light source is for example a light emitting diode and a fluorescent lamp.

Referring to FIG. 3b, in an embodiment of the present application, the liquid crystal display panel further comprises an array thin film transistor 320 and a color filter 310.

In an embodiment of the present application, the material of the prisms 334 is a thermoplastic resin or a synthetic material containing a thermoplastic resin, and the thermoplastic resin is a transparent material in the range of visible light. The examples of the thermoplastic resin may comprise acetal resin, acrylic resin, polycarbonate resin, polystyreneresin, polyester resin, vinyl resin, polyphenyl ether resin, polyolefin resin, cycloalkene resin, acrylonitrile-butadiene-styrene copolymer, polyacrylate, polyaryl sulfone resin, polyethersulfone resin, polyphenyl thioether resin, polyethylene naphthalate resin, polyethylene resin and fluorine resin.

The present application can solve the problem of the side light leaking of the edges of frameless liquid crystal displays, without applying a circle of side seal around the frameless liquid crystal displays to absorb the leaked light, which simplifies the manufacturing process. Additionally, the present application, by using the compound-angle prism sheet, forms total reflection at the periphery, reducing the light that is refracted out of the glass end face, and thus prevents the light leaking of the edges of frameless products.

The wordings of “in some embodiments” and “in various embodiment” are repeatedly used. They generally do not refer to the same embodiment, but they may refer to the same embodiment. The wordings of “comprise”, “have” and “include” are synonyms, unless the context shows other meanings.

The above descriptions are merely preferable embodiments of the present application, and are not limiting the present application in any form. Although the present application is disclosed as above by using the preferred embodiments, they are not intended to limit the present application. A person skilled in the art can make alternations or modifications by using the technical contents that are disclosed above to obtain equivalent embodiments without departing from the scope of the technical solutions of the present application. However, all the contents that do not depart from the technical solutions of the present application, and any simple amendments and equivalent variations and modifications that are made to the above embodiments according to the technical essence of the present application, fall within the scope of the technical solutions of the present application.

What is claimed is:

1. A liquid crystal display device, comprising:
a backlight module;
a liquid crystal display panel; and
a prism sheet, provided between the backlight module and the liquid crystal display panel, wherein the prism sheet comprises: a brightness enhancement film; and a plurality of prisms, and the prisms are distributed on the brightness enhancement film individually, and the prisms have at least one angle, and an angle of the prisms distributed in a peripheral area is smaller than an angle of the prisms distributed in an in-plane area.

2. The liquid crystal display device according to claim 1, wherein the angles of the prisms are in a range of 30 degrees to 60 degrees.

3. The liquid crystal display device according to claim 1, wherein the angles of the prisms in the peripheral area of the brightness enhancement film are in a range of 30 degrees to 45 degrees, and the angles of the prisms in the in-plane area of the brightness enhancement film are in a range of 45 degrees and 60 degrees.

4. The liquid crystal display device according to claim 3, wherein the in-plane area is corresponding to a displaying region of the liquid crystal display panel, and cross-sections of structures of the prisms in the in-plane area are of an isosceles triangle shape; and the peripheral area is corresponding to a non-displaying region of the liquid crystal display panel, and cross-sections of structures of the prisms in the peripheral area are of a right triangle shape, and acute angles of the right triangles in the peripheral area are facing the in-plane area.

5. The liquid crystal display device according to claim 1, wherein the prisms are a plurality of triangular edged strips and are formed at the light-exiting face of the prism sheet, and the triangular edged strips are arranged successively.

6. The liquid crystal display device according to claim 1, wherein the prism sheet has a compound angle of various prism angles.

7. The liquid crystal display device according to claim 1, wherein the prism sheets have no gap therebetween.

8. The liquid crystal display device according to claim 1, wherein the prism sheets are arranged on a flat plate, and the prism sheets have constant gaps.

9. A set of prism sheets, comprising one or more prism sheets, the prism sheets being provided between the backlight module and the liquid crystal display panel, wherein the prism sheet comprises: a brightness enhancement film; and a plurality of prisms, and the prisms distributed on the brightness enhancement film individually have at least one angle, and an angle of the prisms distributed in a peripheral area is smaller than an angle of the prisms distributed in an in-plane area.

10. The prism sheet according to claim 9, wherein the angles of the prisms are all in a range of 30 degrees to 60 degrees.

11. The prism sheet according to claim 9, wherein the angles of the prisms in the peripheral area of the brightness enhancement film are in a range of 30 degrees to 45 degrees, and the angles of the prisms in the in-plane area of the brightness enhancement film are in a range of 45 degrees and 60 degrees.

12. The prism sheet according to claim 11, wherein the in-plane area is corresponding to a displaying region of the liquid crystal display panel, and cross-sections of structures of the prisms in the in-plane area are of an isosceles triangle shape; and the peripheral area is corresponding to a non-displaying region of the liquid crystal display panel, and cross-sections of structures of the prisms in the peripheral area are of a right triangle shape, wherein acute angles of the right triangles in the peripheral area are facing the in-plane area.

13. The prism sheet according to claim 9, wherein the prisms are a plurality of triangular edged strips and are provided at the light-exiting face of the prism sheet, and the triangular edged strips that are arranged successively.

14. The prism sheet according to claim 9, wherein the prism sheet has a compound angle of various prism angles.

15. The prism sheet according to claim 9, wherein the plurality of prism sheets have no gap therebetween.

16. The prism sheet according to claim 9, wherein the plurality of prism sheets are arranged on a flat plate, and the plurality of prism sheets have constant gaps therebetween.

17. A liquid crystal display device, comprising:
a backlight module;
a liquid crystal display panel; and
a prism sheet, provided between the backlight module and the liquid crystal display panel, wherein the prism sheet comprises: a brightness enhancement film; and a plurality of prisms, and the prisms are distributed on the brightness enhancement film individually, and the prisms have at least one angle, and an angle of the prisms distributed in a peripheral area is smaller than an angle of the prisms distributed in an in-plane area;
wherein the angles of the prisms are all in a range of 30 degrees to 60 degrees;
wherein the angles of the prisms in the peripheral area of the brightness enhancement film are in a range of 30 degrees to 45 degrees, and the angles of the prisms in the in-plane area of the brightness enhancement film are in a range of 45 degrees and 60 degrees; the in-plane area is corresponding to a displaying region of the liquid crystal display panel, and cross-sections of structures of the prisms in the in-plane area are of an isosceles triangle shape;
and the peripheral area is corresponding to a non-displaying region of the liquid crystal display panel, and cross-sections of structures of the prisms in the peripheral area are of a right triangle shape, wherein acute angles of the right triangles in the peripheral area are facing the in-plane area;
the prisms are a plurality of triangular edged strips and are provided at the light-exiting face of the prism sheet, and the triangular edged strips are arranged successively; and
the prism sheet has a compound angle of various prism angles; wherein a material of the prisms is a thermoplastic resin or a synthetic material containing a thermoplastic resin, and the thermoplastic resin is a transparent material in the range of visible light.
